(19) United States
(12) Patent Application Publication
(10) Pub. No.: US 2013/0111443 A1
(43) Pub. Date: May 2, 2013

(54) Methods and Systems for Source Control Management

(71) Applicants: Uma S. Kedla, Phoenix, AZ (US); John D. Randles, Scottsdale, AZ (US); Imran S. Shah, Scottsdale, AZ (US)

(72) Inventors: Uma S. Kedla, Phoenix, AZ (US); John D. Randles, Scottsdale, AZ (US); Imran S. Shah, Scottsdale, AZ (US)

(73) Assignee: American Express Travel Related Services Company, Inc., New York, NY (US)

(21) Appl. No.: 13/285,343

(22) Filed: Oct. 31, 2011

(51) Int. Cl. G06F 9/44

(52) U.S. Cl. 717/122; 717/120

(57) ABSTRACT

A source control management system comprises accessing a TPF platform via a web interface. The system checks out a selected component of a package and transmits a copy of the component to a local computer for modification by a user. The user is able to edit and modify the component without having to download the entire package, which is much faster. Once the user completes the editing, the source control management system receives an edited copy of the component from the local computer. Furthermore, the system includes checking in the edited copy and comparing to the unedited component while providing component level warnings of differences. A second copy of the component may be transmitted for independent modification. This allows for multiple users to work on the same component at the same time. The multiple versions of the component are combined and the appropriate modifications are made to the primary component.

### FIELD

The present disclosure generally relates to source control management. More particularly, the present disclosure relates to methods, systems and computer program products for transaction processing facility (TPF) source control management.

### BACKGROUND OF THE DISCLOSURE

TPF is an IBM real-time operating system, which delivers fast, high-volume, high-throughput transaction processing, while handling large, continuous loads of essentially simple transactions across large, geographically dispersed networks. TPF is capable of running on a multiprocessor, for example, on mainframe systems having more than one central processing unit (CPU). One example in which TPF finds extensive application is design and development of source control management tools.

Source control refers to management of changes to documents, programs and other information stored as computer files. Source control management is used extensively in software development, where a team of people may change the same files. Changes are usually identified by a number or letter code (often termed as the revision number, revision level, or simply revision). Source control managers also provide for revision control, where changes to source code are tracked and controlled. A baseline in source control refers to an approved revision of a document or source file, from which changes can be made and/or tracked. The source control manager also allows a user to create, delete and update packages as well as check-in and check-out components to the packages. When a user checks-out a component from the source control manager's repository to a package, a copy of the component is transmitted to the user's local computer. The user can edit the copy and check-in the component back into the repository, where the edited component gets saved into the repository and is available for check-out and editing for all users.

Standard source repositories in existing source control managers are not well suited to the TPF operating environment and suffer from several limitations and disadvantages. For example, in conventional source control managers, a group of users is designated who are notified every time a component associated with a package is modified. When a user checks out and checks in a particular component of a package, email notifications are sent to users from the group indicating occurrence of the corresponding events. The functioning of the source control manager may not require any action by the notified user on all the emails. Hence, this can result in a lot of junk emails in the notified user's mailbox. The situation can get worse if multiple component modifications are performed by multiple users, causing the notified users' mailboxes to get flooded with notification emails.

Further, to modify a component within a package, the user typically has to list the complete repository from the source control manager. For example, suppose that a package repository contains 10,000 components, including components A. To modify component A, a user first has to download the complete list of all components to a local computer. Thus, other components, which are not to be modified are listed along with component A, thereby resulting in a possible wastage of resources and time. This can significantly reduce the efficiency of the process and thereby affect user experience.

In light of the foregoing, there exists a need for a system, method and/or computer program product that provides a more efficient and easier use of source control management.

### SUMMARY

In various embodiments, a computer-based system for source control management comprises a system configured for accessing a transaction processing facility (TPF) platform via a web interface, where the web interface allows access to a data repository from within the web interface and a TPF toolkit. The source control management system further includes checking out at least one selected component of a package of the TPF platform and transmitting a copy of the at least one selected component to a local computer for modification by a user. The user is able to edit, revise, and modify the selected component without having to download the entire data repository. Once the user completes the editing, the source control management system receives an edited copy of the selected component from the local computer. Furthermore, the source control management system includes checking in the edited copy of the selected component and comparing the edited copy of the selected component with the selected component prior to modification. The system may provide component level warnings of differences between the edited copy of the selected component and the selected component. The component level warnings may include visible markers of conflicting code.

In order to select the desired component, the source control management system may be capable of searching multiple components of the package and filtering by search criteria. The search criteria includes at least one of time of last edit, identity of editor, time of creation, status of the multiple components, and classification of the multiple components. Furthermore, the source control management system may be configured to add a new component to the package, where the structure and properties of the package are automatically generated by the source control management system.

Authorization to access the components may be restricted to an approved team of users. Also, an individual user may be added to, or deleted from, the approved team of users, allowing for more flexible control access. Moreover, a listing of the approved team of users is available to individuals of the approved team. The system may also notify at least one user of the approved team in response to updates of the package at different stages of a staging workflow. The at least one user of the approved team has the ability to opt-out of the notifying communications.

One advantage of the disclosed system is that a second copy of the selected component may be transmitted to a second local machine for independent modification. This allows for multiple users to work on the same component at the same time. The source control management system combines the multiple versions of the component and enables the appropriate and desired modifications to be made to the primary component. As part of the multiple users working on the same component, the source control management system tracks if version updates were made to the selected component while the copy of the selected component was checked out.

Another advantage of the disclosed system is the ability to build, at the source control management system, the package via the web interface. Other options may exist to the user via the web interface with respect to controlling the package. For example, the user capabilities may include freezing the package via the web interface, where no changes are permitted to the package. Another example is that the user capabilities may include promoting, via the web interface, the package to a staging workflow. As part of the building and overall system control, in various embodiments, the source control management system may automatically create a baseline snapshot of the package in response to the package being at least one of loaded to production or falling back. Furthermore, notifying, by the source control management system, an approved team of users in response to the creating the baseline snapshot may be another capability.

However, the source control management system may also be configured to automatically create a baseline snapshot of the package based on a predetermined schedule. For example, a baseline snapshot may be created on a daily or weekly basis. With respect to creating baseline packages, in various embodiments, the source control management system archives packages after a first predefined time period in response to the creation of the baseline snapshot. For example, the package may be archived one month after the baseline snapshot was created. Similarly, the source control management system may delete archived packages after a second predefined time period. The second predefined time period, for example, may be one to two months or more. The user may be notified, prior to expiration of the second predefined time period, of the upcoming deleting of the archived packages so that deletion may be prevented.

In various embodiments, a source control management system comprises a computer system having a transaction processing facility (TPF) platform, where the computer system includes a repository, database access program, script library, secure shell, and Java servlet. The source control management system also comprises a toolkit module having a toolkit plugin that interacts with the Java servlet, a web interface module for user interaction with the computer system, and a data storage module for storing a package of the TPF platform. The data storage module may interact with the local file system, a remote file system, the local database system, and/or a database located on a remote system. The package is made up of multiple components. A user may check out a selected component and the system transmits a copy of the selected component to a local computer, where the user edits the selected component. Furthermore, the system receives an edited copy of the selected component from the local computer. The computer system checks in the edited copy of the selected component and compares the edited copy of the selected component with the selected component. Moreover, the system may provide component level warnings of differences between the edited copy of the selected component and the selected component.

In various embodiments, the computer system of the source control management system includes multiple repositories, where different levels of authorization are required for access to individual repositories of the multiple repositories. A secure communication channel may be used to exchange data between the source control management system and the local computer. Specifically, the secure shell may communicate to a remote system via the secure communication channel.

### BRIEF DESCRIPTION OF THE DRAWINGS

The features and advantages of the present disclosure will become more apparent from the detailed description set forth below when taken in conjunction with the drawings, in which like reference numbers indicate identical or functionally similar elements. Additionally, the left-most digit of a reference number identifies the drawing in which the reference number first appears.

FIG. 1 is an overview of an exemplary system for source control management, in accordance with one embodiment of the present disclosure;

FIG. 2 is a flowchart illustrating one example process for source control management, according to various embodiments of the present disclosure;

FIG. 3 is an exemplary user interface for source control management; in accordance with various embodiments of the present disclosure;

FIG. 4 is an exemplary user interface for checking in and checking out components; in accordance with various embodiments of the present disclosure;

FIG. 5 is an exemplary user interface for querying packages; in accordance with various embodiments of the present disclosure;

FIG. 6 is an exemplary user interface for accessing tools; in accordance with various embodiments of the present disclosure;

FIG. 7 is an exemplary user interface for creating a package; in accordance with various embodiments of the present disclosure;

FIG. 8 is an exemplary user interface for indicating dependencies; in accordance with various embodiments of the present disclosure;

FIG. 9 is an exemplary database layout for source control management; in accordance with various embodiments; and

FIG. 10 is a block diagram of an exemplary computer system, according to various embodiments.

### DETAILED DESCRIPTION

“Component” may include a software package comprising one or more source segments, and/or one or more objects. Furthermore, a software component is a unit of composition with contractually specified interfaces and explicit context dependencies only. A software component can be deployed independently and is subject to composition by third parties.

“Fallback” may include a mechanism for backing out a change by carrying forth programmed instructions despite malfunction or failure of the primary device.

“Sandbox” may include a mechanism for creating packages which are not intended for loading to a production system. It is often used to execute untested code and adhoc code. The sandbox may assist in protecting the system from damaging changes to the program.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: information on scheduled changes; client data; merchant data; financial institution data; and/or like data useful in the operation of the system. As those skilled in the art will appreciate, user computer may include an operating system (e.g., Windows NT, Windows 95/98/2000, Windows XP, Windows Vista, Windows 7, OS2, UNIX, Linux, Solaris, MacOS, etc.) as well as various conventional support software and drivers typically associated with computers. A user may include any individual, business, entity, government organization, software and/or hardware that interact with a system.

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, hand held computers, personal digital assistants, set-top boxes, workstations, computer-servers, main frame computers, mini-computers, PC servers, pervasive computers, network sets of computers, personal computers, such as iPads, iMACs, and MacBooks, kiosks, terminals, point of sale (POS) devices and/or terminals, televisions, or any other device capable of receiving data over a network. A web-client may run Microsoft Internet Explorer, Mozilla Firefox, Google Chrome, Apple Safari, or any other of the myriad software packages available for browsing the internet.

Practitioners will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In an exemplary embodiment, access is through a network or the Internet through a commercially-available web-browser software package.

As those skilled in the art will appreciate, a web client includes an operating system (e.g., Windows NT, 95/98/2000/CE/Mobile, OS2, UNIX, Linux, Solaris, MacOS, PalmOS, etc.) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In an exemplary embodiment, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In an embodiment, various components, modules, and/or engines of system 100 may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1998); Java 2 Complete, various authors, (Sybex 1999); Deborah Ray and Eric Ray, Mastering HTML 4.0 (1997); and Loshin, TCP/IP Clearly Explained (1997) and David Gourley and Brian Totty, HTTP, The Definitive Guide (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/groups/SNS/cloud-computing/cloud-def-v15.doc (last visited Feb. 4, 2011), which is hereby incorporated by reference in its entirety.

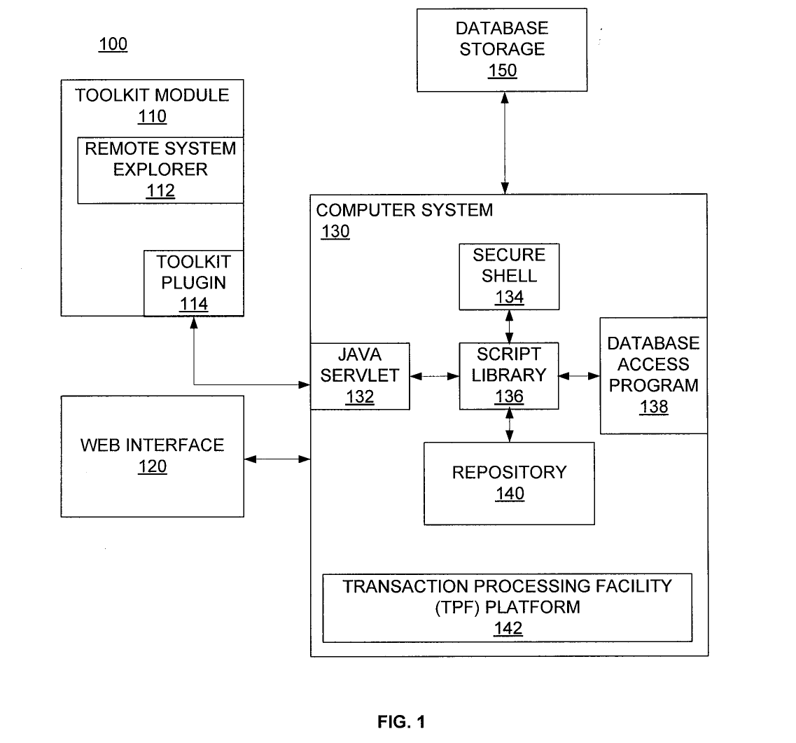

FIG. 1 is an overview of an exemplary system 100 for source control management, in accordance with various embodiments. System 100 includes a computer system 130 (interchangeably referred to as a Source Control Manager (SCM) 130) for implementing a source control manager and/or having a transaction processing facility (TPF) platform 142, for example, z/TPF platform. Computer system 130 may include, for example, a repository 140, a database access program 138, a script library 136, a secure shell 134, and a Java servlet 132. System 100 further includes a database storage module 150, a toolkit module 110 and a web interface module 120.

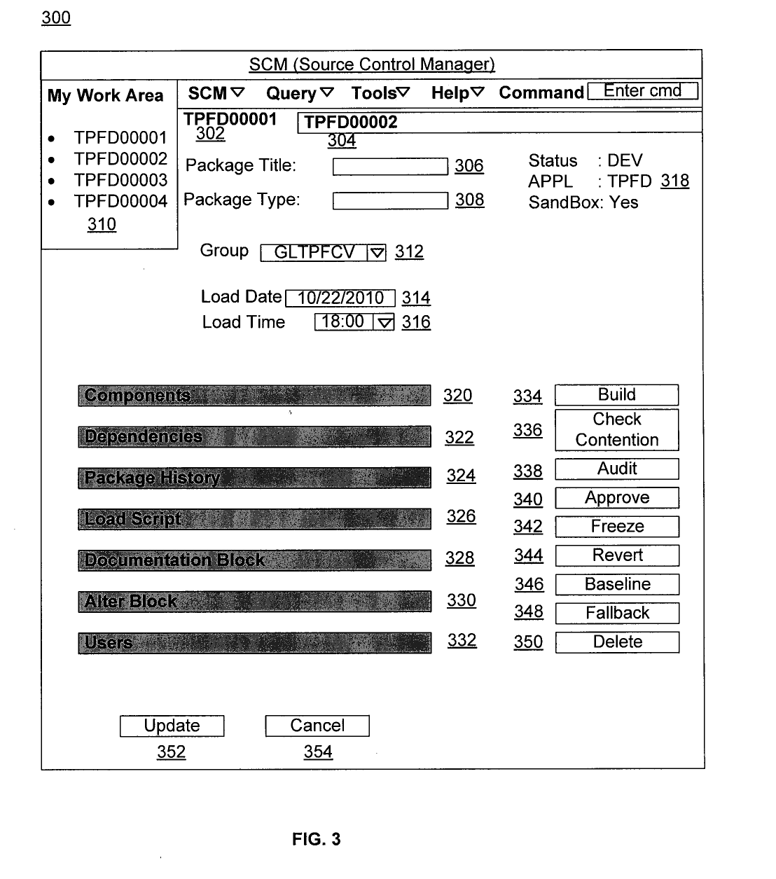

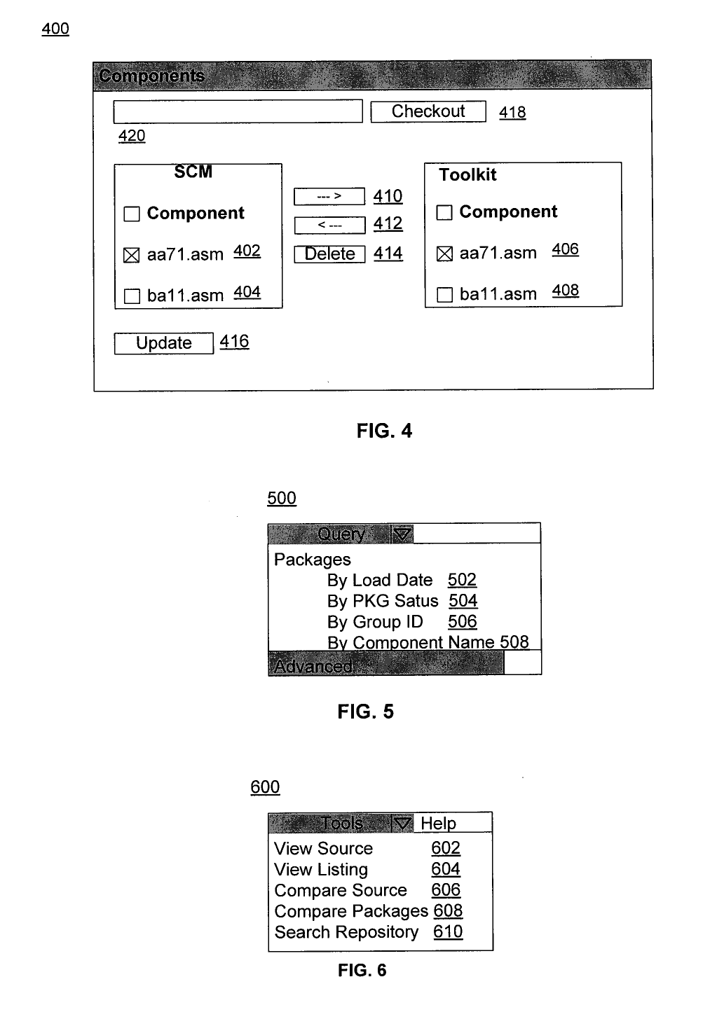

Toolkit module 110 may be an integrated development environment for TPF applications and may be present on the user's local computer. Additionally, toolkit module 110 enables the user to edit, compile, debug and deploy TPF applications. Further, the user may also access SCM 130 via web interface module 120. Web interface module 120 may provide the user with different user interfaces for implementing different functionalities. For example, web interface module 120 may provide an interface to the user for building a package, as shown in FIG. 3; and may provide a separate interface to the user for checking-in/checking-out a component of a package, as shown in FIG. 4. Various other user interfaces are also described herein. Toolkit module 110 or web interface module 120 may also be used to view a repository, wherein the complete repository is displayed page-by-page on the user's local computer. Further, toolkit module 110 may include a toolkit plug-in 114 that communicates with Java servlet 132 of SCM 130 and allows the user to check-out/check-in components from/into SCM 130. Toolkit module 110 may reside on the user's local computer or may reside remotely from the local computer and the user may access toolkit module 110 via a suitable interface. Further, toolkit module may include remote system explorer 112, which may be enabled to exchange data with secure shell 134 of computer system 130.

Java servlet 132 responds to requests and extends applications hosted by computer system 130 as described below. In response to a user requesting access to computer system 130, Java servlet 132 executes Java code to serve JSP pages corresponding to the user's request. These JSP pages may call corresponding classes, which in turn may invoke scripts, for example, Linux scripts, to perform functions corresponding to the user's requests. For example, if the user requests creation of a new package, the JSP page “Package.jsp” may be served by Java servlet 132. Package.jsp may include the list of packages and their details; and also allows for updating of packages, creation of new packages, and freezing, approving, reverting and fallback of existing packages. Package.jsp calls the corresponding class “package.java”, which is used to create, delete and update packages, as well as check-out and check-in components. Package.java invokes the appropriate Linux script which allows the user to create a new package. Package.jsp is, thus, served to the user in response to the user's request. In various embodiments, Java servlet 132 may be implemented using a servlet container such as Apache Tomcat. Script library 136 may store scripts that are invoked to perform various functions associated with the users' requests.

Database storage module 150 may be one single storage module or may be in the form of multiple interconnected storage modules. Database storage module 150 may be enabled to store information related to packages such as package ID, creator, owner group, creation date and time, load date and time, status, package type, approver, approve date and time, user responsible for freezing the package, freeze date and time, user responsible for reverting, revert date and time, reason for reverting, baseline date and time, fallback date and time, reason for fallback, reason for rejection, user fields, baseline order, sandboxing configuration, description of the package, audit date and time, audit return code, edit log and/or the like. Further, database storage module 150 may be enabled to store information specific to a component within a package such as component ID, component name, component folder and/or the like. Database storage module 150 may employ any type of database, such as relational, hierarchical, graphical, object-oriented, and/or other database configurations.

Database access program 138 may be used to access data stored in database storage module 150. In various embodiments, database access program 138 may be implemented using a database management system such as MySQL, although any other suitable database management system may be used. Secure shell 134 may be configured to use a secure communication channel to exchange data with a remote system explorer 112 of toolkit module 110. Any version of secure shell including, without limitation, SSH-1 and SSH-2 may be used in implementing secure shell 134.

When a first user checks out a component from computer system 130 using either toolkit module 110 or web interface module 120, a copy of the component is transmitted to the first user's local computer. The user is able to modify the selected component using either toolkit module 110 or web interface module 120 and check in the edited component into computer system 130. Computer system 130 compares the edited copy of the selected component with the selected component and provides component level warnings of differences between the edited copy of the selected component and the selected component. The component level warnings may be displayed to the user via toolkit module 110 or via web interface module 120. Further, computer system 130 may enables a second user to check-out a second copy of the selected component and may send the second copy to the second user's local computer for independent modification.

Repository 140 may include one or more packages, each package having one or more components. The user may be allowed to view details of packages and associated components within repository 140. Further, access to repository 140 by users may be controlled by providing authorizations for selected users. In various embodiments, different levels of authorizations may be provided to different users. For example, levels of authorizations may include no access, read-only, modify, approve, audit etc. In another implementation, computer system 130 may include multiple repositories. The user may be allowed to view details of packages and associated components within each repository via toolkit module 110 or via web interface module 120. Further, each of the repositories may be configured to have different levels of authorization for access to data contained within them. Authorization levels can also be provided at group level. For example, one repository may be accessed by all users whereas only project managers are allowed access to another repository. In yet another implementation, authorization levels for users may be configured at package or component level.

In various embodiments, the user is able to check out the component to the package and/or use toolkit module 110 or web interface 120 to edit the component copy and check in the edited copy, whereupon the edited copy is stored in the repository from where it was originally checked out. In response to the user checking in the component, computer system 130 compares the edited copy of the selected component with the selected component and provides component level warnings of differences between the edited copy of the component and the selected component.

Additionally, a second copy of the component may be checked out by a second user and sent to a second user's local computer for modification. The edited second copy of the selected component may be checked into computer system 130 using toolkit module 110 or web interface module 120 on the second user's local computer. The check-out, editing and check-in of the component by a user can occur independently of the check-out, modification and check-in of the component copy by the other users on their respective local computers. When two users simultaneously check out, modify and check in the same component, computer system 130 may provide to the first user, component level warnings of differences between the copy of the component edited by the first user and the component; and to the second user, component level warnings of differences between the copy of the component edited by the second user and component. Further, the first user, the second user and/or a third user, such as, an administrator, may be provided with component level warnings of differences between the copy edited by the first user and the copy edited by the second user. Still further, computer system 130 may also allow multiple users to check out, modify and check in different components of the same package. Computer system 130 thus allows multiple users to work on the same package as well as allows the same component to be checked out and modified in multiple packages at the same time. Computer system 130 may also check if version updates were made to the selected component while the copy of the selected component was checked out. For example, a first user and a second user may separately check out a component. In response to one user, for example, the second user making version updates to the component, computer system 130 may track the version update and provide, to other users, in this case, the first user, with information indicative of the version update. The version update information may be provided when the version gets revised or when the first user checks-out the selected component or when the first user is checking-in an edited copy of the component. Computer system 130 may also keep a track of which version of a component was checked out and which version was checked in. Further, computer system 130 may also be configured to promote a package to a staging workflow wherein a component is getting promoted and going into production before the package. Such packages may be flagged by computer system 130, for example, by using visual indicators; and details of the component may be displayed within the package. The visual indicators may be one or more of flags, pop-ups, color coded markers and flash-alerts. Alternatively, the packages may be flagged by computer system 130 using audible alerts. Additionally, users may be sent email notifications about components getting promoted and going into production before the package. Computer system 130 is also configured to flag a package including a component getting promoted and going to production before the package.

In a further embodiment, computer system 130 may allow creation of a list of approvers associated with a package. The approvers are further notified by computer system 130 when a user attempts to make a change to a component within the package. For example, the approvers may be notified via an email. Alternatively, computer system 130 may notify approvers when the approvers access the TPF platform via toolkit module 110 or via web interface 120. The notification may be in the form of a visible alert, an audible alert, a message and/or the like. According to one example implementation, the approvers may be provided with an authorization key with two hyperlinks. An approver can click on the first hyperlink to approve the change and the second hyperlink to reject the change. It will be apparent that other techniques may be used to allow the approvers to approve and/or reject the changes. Approval may be required from any one approver, from more than one approver, or from all approvers. In various embodiments, the approvers may be associated with specific groups and approvals may be required from at least one approver from each of the specific groups. For example, any change to a component may require approval from at least one associated project leader and at least one associated project manager. Further, administrators, such as, project managers, may be provided with special views of packages and users. For example, the administrators can view current configuration values, update configuration values and maintain repositories and users.

In additional embodiments, computer system 130 may automatically create a baseline snapshot of the package. The baseline snapshot may be created based on a predetermined schedule. For example, a baseline snapshot may be created on a daily or weekly basis. The baseline snapshot may also be automatically created in response to the package being loaded to production or falling back. Further, computer system 130 may also notify the approved team of users about the creation of the baseline snapshot. Additionally, if a package that is scheduled for load is not detected as having been loaded or has been tracked to have fallen back, computer system 130 sends an email or any other notification; notifying appropriate users of action required for correction. In yet another embodiment, computer system 130 archives a package after a first pre-determined time period (archival time) has lapsed after the creation of the baseline snapshot. For example, the package may be archived one month after the baseline snapshot was created. Further, computer system 130 may delete an archived package after a second pre-determined time period (deletion time) has lapsed after the creation of the baseline snapshot. The second predefined time period, for example, may be one to two months or more. Prior to the expiry of the second pre-determined time period, computer system 130 may notify the user about the impending deletion of the package. The first and second pre-determined time periods may be based on the installation date of the package. Computer system 130 may also allow the user to view previous versions of packages that have gone into production. Further, computer system 130 may additionally allow the user to compare components across different versions of packages.

Computer system 130 may also enable the user to add a new component to a package. In various embodiments, computer system 130 may automatically generate the structure and properties of the package when a new component is added to the package. For example, computer system 130 may automatically provides values for the configurable fields, such as “Group”, “Repository type” and “Application” fields. In various embodiments, computer system 130 bases the provided values on the file extension(s) of the package. Additionally, computer system 130 may select a location for the new component within the package and updates data within database storage module 150 to include the new component. The user may also be provided with an option to modify the values provided by computer system 130.

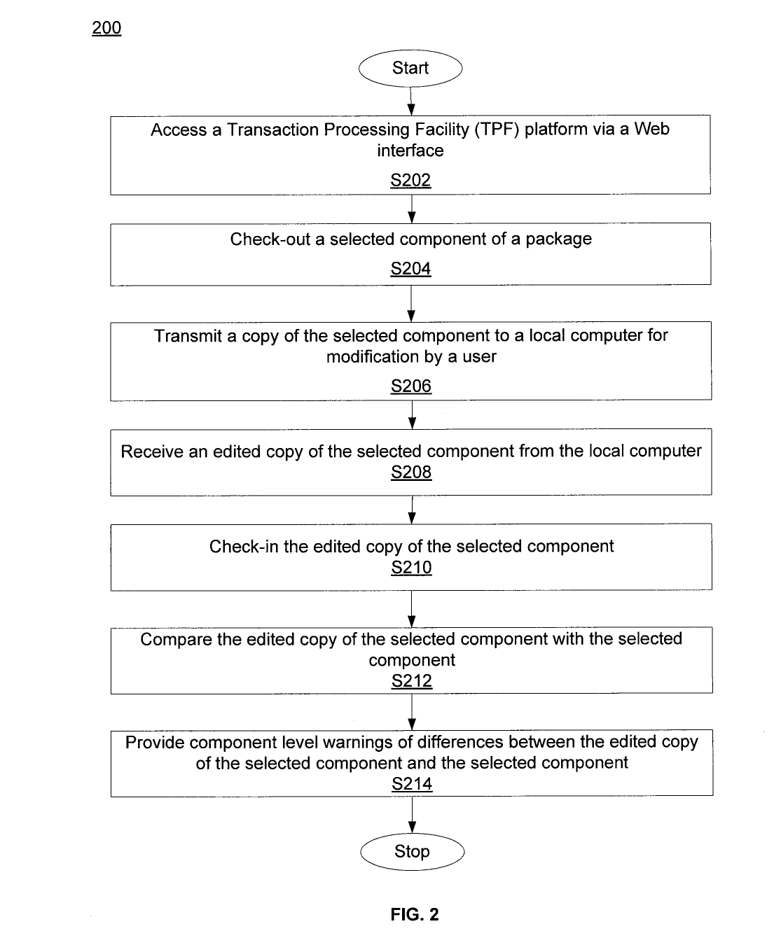

With reference to FIG. 2, an exemplary flowchart illustrating an exemplary process 200 for source control management is presented. A Transaction Processing Facility (TPF) platform is accessed via a web interface (S202). The web interface provides a user with access to a data repository and a toolkit. The web interface may be a web browser such as Internet Explorer, Mozilla, Chrome, Netscape Navigator or any other web browser. The data repository may include one or more packages, each package having one or more components.

The system, for example, SCM 130, enables a user to select a component of a package of the TPF platform. The system checks out the selected component within the package (S204). Further, the system transmits a copy of the selected component to a local computer of the user (S206). The user is able to edit, revise and modify the selected component. The user may do so using Toolkit module 110. The system receives an edited copy of the selected component from the local computer (S208), for example, via the web interface. The system further checks in the edited copy of the selected component into the TPF platform via the web interface (S210). The system compares the edited copy of the selected component with the selected component (S212). In response to the comparison, the system provides component level warnings of differences between the edited copy of the selected component and the selected component (S214). In various embodiments, components in contrast will be visually marked indicating to the user that the difference should be resolved before freezing the changes. SCM 130 may also provide the user with a “Check Contention” button which would list the order of packages based on load date, allowing the user to look for possible contentions with components in their package. The component level warnings may include visible markers of conflicting code. For example, as the visible markers may be, without limitation, flags, pop-ups, color coded markers, text highlighting, flash-alerts and/or the like. Further, the component level warnings may also include audible alerts. The details of the component level warnings may also be sent to selected users via email or may be displayed in the web interface when the user accesses the package having such a component. In various embodiments, a component may be selected and checked out from one package, edited on the local computer of the user and checked in to a second package. The system then provides component level warnings of differences between the edited copy of the selected component and a corresponding component from the second package.

In various embodiments, the system may restrict access to a selected component. The system allows for configuration of one or more users as approved team of users for the selected component. In these cases, only users of the approved team of users are authorized to access and modify the selected component. In various embodiments, users not belonging to the approved team of users for a component may not be able to access the selected component. Alternatively, such users may only be able to access, but not modify, the selected component. The system may also allow for a non-approved user to be added to the approved team of users at a later stage. The addition of the user to the approved team of users may be performed by any user of the existing approved team of users and/or by a system administrator. In another implementation, the system may provide a listing of the approved team of users to individual users of the approved team of users. Additionally, one or more users of the approved team of users may receive notifications regarding updates to component(s) and/or updates to the package as the package moves through different stages of the workflow. The system may also allow an approved user to opt out of the notifying so that the user does not receive or selectively receives the notifications. The system may also allow a user who has previously opted-out to opt-in at a later time, so that the user starts receiving the notifications again. The above described authorized access by creating a group of users may also be configured for an entire package. In this case, the approved users are able to access and modify all the components within the package, whereas users who are not part of the approved team of users, cannot access the package and the components therein.

FIG. 3 shows an exemplary user interface 300 for source control management, in accordance with various embodiments of the present disclosure. User interface 300 includes a work area 310 which enables a user to open a package from a repository of the TPF platform. As shown, multiple packages 302 and 304 may be opened by the user in a tabbed manner with an active package (package 302 in this example) being distinguished from non-active packages (for example, package 304) in a visual manner. For the currently active package, package 302, user interface 300 allows the user to configure parameters associated with the package. Examples of the parameters include, but are not limited to, package title, package type, group associated with the package, load date, load time and/or the like. User interface 300 may include one or more text fields to set one or more parameters. In the current example, user interface 300 includes text fields 306, 308 and 314, to set the package name, the package type and load date, respectively. User interface 300 may also enable to select appropriate parameter values using drop-down list (such as, Group 312 and Load Time 316). Examples described herein are for illustration purpose only and other variations are contemplated. For example, user interface 300 may include other user interface elements, such as, radio buttons, check boxes, menu options etc., to enable the user to configure the parameters. The user may save the changes made to the parameters using “Update” button 352 or may discard them using “Cancel” button 354.

User interface 300 can also provide other information 318 related to the package such as Status, APPL configuration and Sandboxing configuration etc. In addition, user interface 300 may provide additional options to the user related to the package. In one example implementation, these options may present separate user interface to perform associated actions. For example, the user can click on “Components” 320 to access the components within the package. In this case, the user may be presented with a separate user interface to configure parameters related to the components and/or manipulate the components. Further, dependencies between packages can be accessed and/or modified by clicking on “Dependencies” 322. Similarly, clicking on “Package History” 324 allows the user to view package history, such as, date when the package was created, the user who created the package, past changes in configurations, users responsible for the past changes, information on previous versions of the package that went to production and/or any other historical information related to the package. “Load Script” 326 may include load and fallback instructions to and from production and/or instructions to load the package to test the system. Load Script may be generated when the user builds the modifications. In various embodiments, manual intervention for baselining packages is not necessary. Instead, packages are autobaselined in SCM when Package is loaded to Production of the TPF system. Furthermore, email notification may be sent out upon successful baseline of packages. “Documentation Block” 328 allows the user to record information related to the change that is being implemented. It may list information like change description, special load instruction, validation instructions and required justification text for emergency type loads. The user may also be able to modify and save the documentation information associated with the package. “Alter block” 330 is configured to allow the user to specify the functional messages or entries that will be applied to production during load. It also provides an option for the user to specify the order in which these entries will be applied in combination with the components in the package. Further, “Users” 332 may provide a list of users associated with the package and relevant details, such as, name, department, designation, role, authorization level, approval rights etc. of the users. In various embodiments, users belonging to a different group may be provided access to modify or approve a particular SCM Package by including additional users under a Users tab.

In addition, user interface 300 may further enable the user to perform one or more actions on the package. For example, the user may build the package via the web interface using “Build” 334. The build output may be displayed to the user. In one example implementation, the user may be able to run the build against a toolkit project. Further, the user may be allowed to build only a part of the package from within the TPF toolkit. Upon completing the build, computer system 130 may also promote the package to a staging workflow. Similarly, buttons “Check Contention” 336, “Audit” 338, “Approve” 340, “Freeze” 342, “Revert” 344, “Baseline” 346, “Fallback” 348 and “Delete” 350 can be used to perform their respective functions on the package. For example, clicking on “Check Contention” button 336 may display multiple baseline versions as well as versions in development and/or frozen/distributed versions. This button displays a history of Package components, allowing the user to look for packages that are already frozen or distributed with same components. “Audit” button 338 may be used for auditing a current version of the package by checking whether the package meets all business rules and lead time for freezing the package before load. “Approve” button 340 may allow a team leader to approve changes after a user developer freezes a modified package. “Freeze” button 342 may allow the user to freeze the package such that no changes are permitted to the package. Freezing of a package may be done only by users owning the package and/or users who are authorized to freeze the package. In addition, freezing the package may move the package to the next staging workflow. “Revert” button 344 may revert the package to testing. “Revert” button 344 may be visible only to users who are allowed to freeze or approve the package, and/or visible only on packages that are frozen or in distributed status. “Baseline” button 346 may allow the user to move the changes in the package to the product repository of that application type. “Fallback” button 348 allows falling back the changes that were baselined earlier. “Delete” button 350 allows the user to delete the package.

FIG. 4 shows an exemplary user interface 400 for accessing components within a package, according to various embodiments. User interface 400 may be configured to display components 402 and 404, present in SCM 130. Further, user interface 400 may also be enabled to display components 406 and 408, present in toolkit module 110. In various embodiments, a user may check-out a component 402 from SCM 130 to toolkit module 110 by clicking on button 410. Further, the user may check-in a component 406 from toolkit module 110 to SCM 130 by clicking on button 412. In various embodiments, the user may be able to check out or move a component 402 from SCM 130 to toolkit module 110 and further check out or move a component 406 from toolkit module 110 to SCM 130. Further, the user may also be enabled to type a component name in text field 420 and check out the corresponding component by clicking on button 418. The user may also be enabled to delete a selected component from SCM 130 by clicking on button 414. Further, in response to the user making requests for multiple check-in and check-out operations using buttons 410, 412 and 418, user interface 400 may allow the user to perform the multiple check-in and check-out operations by clicking on button 416. Thus, the user is able to update SCM 130 and toolkit module 110 to incorporate changes made by the multiple check-in and check-out operations by clicking on button 416.

FIG. 5 shows an exemplary user interface 500 for searching for packages, in accordance with various embodiments. The user may query the repository for one or more desired packages. In one example implementation, user interface 500 allows the user to search the desired packages using one or more default search filters. The search filters may be based on search criteria including, without limitation, load date 502, package status 504, group ID 506, component name 508, owner 510 etc. Further, user interface 500 may provide an advanced filter option to the user. The advanced filter may enable the user to combine more of these criteria or may use other criteria to query the repository. Additionally, user interface 500 may also allow the user to search for one or more components of a package by using search criteria for filtering out the desired components of a package. Examples of the search criteria for components may include, but are not limited to, time of last edit, identity of editor, time of creation, status, classification or any combination thereof. A person skilled in the art will recognize any other suitable criteria that may be used instead of, or in addition to, the search criteria described herein. Additionally, user interface 500 also allows the user to search components using wild cards. User interface 500 may further allow the user to sort packages using fields of his/her choice. For example, the user may be able to sort the packages being displayed by load date, repository or any other suitable field(s).

FIG. 6 is an exemplary user interface 600 accessing one or more tools associated with source control management, in accordance with various embodiments. The tools may include functionalities such as “View Source” 602, “View Listing” 604, “Compare Source” 606, “Compare Packages” 608 and “Search Repository” 610. With respect to these various functionalities and in accordance with various embodiments, View Source 602 shows the component itself, View Listing 604 shows the listing file generated after a source component has been compiled, and Compare Source 606 shows the differences between two source components. Furthermore, in exemplary embodiments, a user may select “Compare Packages” 608 to view a comparison between two or more packages stored in the repository 140. The comparisons displayed to the user may be at package level and/or at component level. The user may select “Search Repository” 610 to search for packages and/or components stored within the repository 140. Further, the user may be allowed to use one or more search criteria such as time of last edit, identity of editor, time of creation, status of components, and classification of components to search for one or more components/packages stored in the repository 140. Additionally, the user may also be allowed to search for components and/or packages outside the repository 140, such as, components/packages stored in database storage 150. These tools are described for the purpose of illustration only and any other tools may be provided to the users.

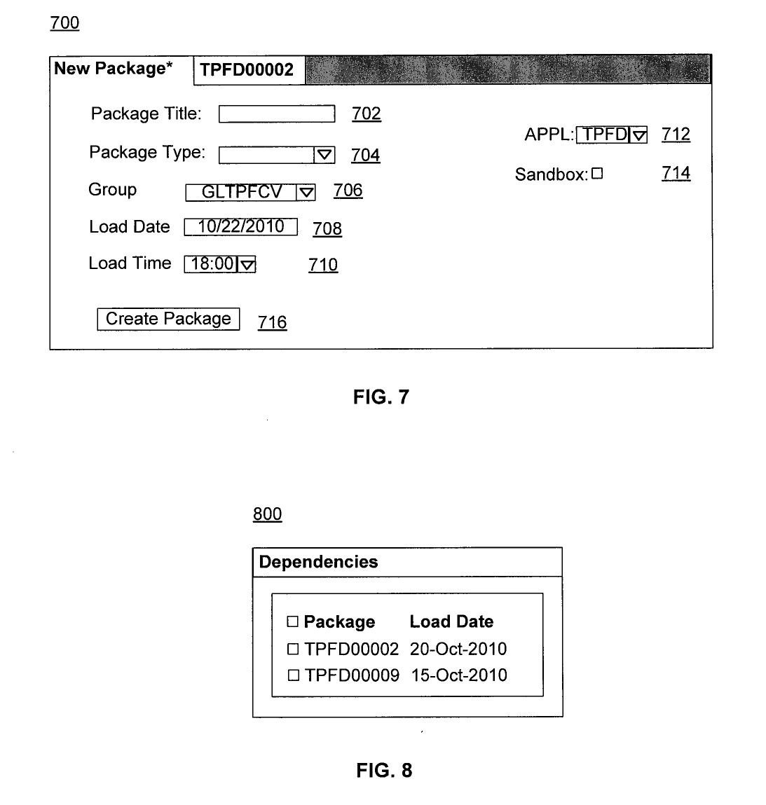

FIG. 7 shows an exemplary user interface 700 for creating a new package, according to various embodiments. The user is provided with fields for providing package-specific information such as package title 702, package type 704, group 706, load date 708, load time 710, APPL (application) 712, and the like. Some or all of this information may be inputted by selecting appropriate option from drop-down menus. Further, options such as sandboxing 714 for a new package may be selected by checking the appropriate check box. Once the user has entered the package specific information, the user can click on “Create Package” button 716 to initiate the package creation.

FIG. 8 shows an exemplary user interface 800 for specifying dependencies within packages, according to various embodiments. The dependencies will be concatenated based on the load date, followed by the load order. This feature may be useful if users have changes that are dependent on each other and packages need to be built based on the order specified under dependency tab.

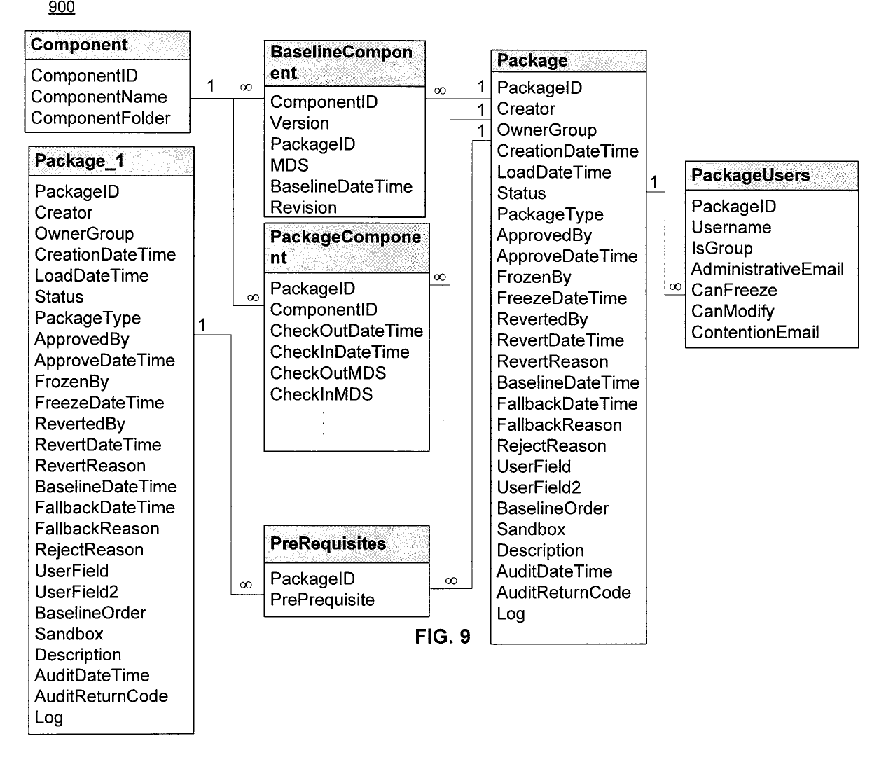

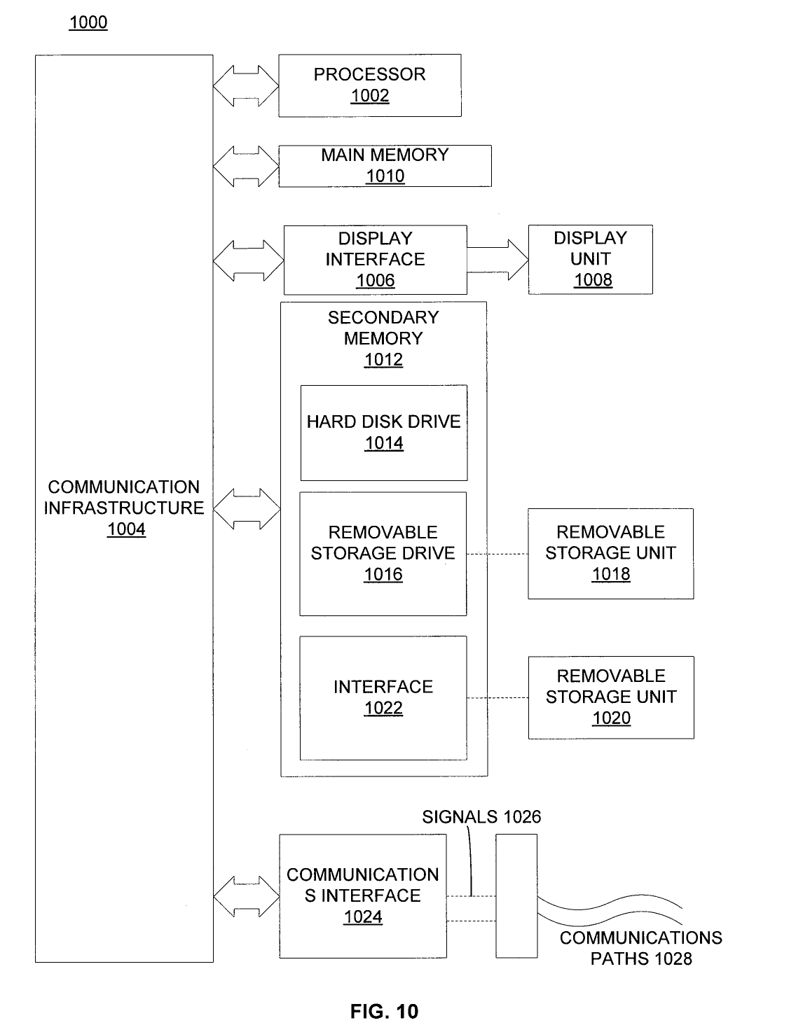

FIG. 9 illustrates an exemplary database layout 900 of database storage module 150, in accordance with one embodiment of the present disclosure. Database layout 900 depicts one or more tables stored in database storage module 150 along with exemplary attributes for the one or more tables. For example, “Component” Tables includes attributes ComponentID, ComponentName and ComponentFolder. In this example, a tuple of ComponentName and ComponentFolder is indicated as a primary key of “Component” Table. Similarly, Tables “Package”, “PackageComponent”, “PackageUsers”, “BaselineComponent” etc. along with corresponding attributes are illustrated. Further, database layout 900 shows exemplary relationships between different tables. For example, as shown, there is one-to-many relationship between “Component” Table and “BaselineComponent” Table, that is, a particular component in stored in “Component” Table may belong to “BaselineComponent” of multiple packages. Similarly, exemplary relationships between other tables are also shown. It will be readily apparent that the layout shown above is for illustrative purpose only and other layout schemes may also be used to build database storage module 150.

The present disclosure (i.e., computer system 100, computer system 130, process 200, any part(s) or function(s) thereof) may be implemented using hardware, software or a combination thereof, and may be implemented in one or more computer systems or other processing systems. However, the manipulations performed by the present disclosure were often referred to in terms, such as comparing or checking, which are commonly associated with mental operations performed by a human operator. No such capability of a human operator is necessary, or desirable in most cases, in any of the operations described herein, which form a part of the system. Rather, the operations are machine operations. Useful machines for performing the operations in the system may include general-purpose digital computers or similar devices. In fact, in accordance with various embodiments, the present system is directed towards one or more computer systems capable of carrying out the functionality described herein.

Computer system 1000 includes at least one processor, such as a processor 1002. Processor 1002 is connected to a communication infrastructure 1004, for example, a communications bus, a cross over bar, a network, and the like. Various software embodiments are described in terms of this exemplary computer system 1000. After reading this description, it will become apparent to a person skilled in the relevant art(s) how to implement the present disclosure using other computer systems and/or architectures.

The computer system 1000 includes a display interface 1006 that forwards graphics, text, and other data from the communication infrastructure 1004 for display on a display unit 1008.

The computer system 1000 may include a main memory 1010, such as random access memory (RAM), and may also include a secondary memory 1012. The secondary memory 1012 may further include, for example, a hard disk drive 1014 and/or a removable storage drive 1016, representing a floppy disk drive, a magnetic tape drive, an optical disk drive, etc. The removable storage drive 1016 reads from and/or writes to a removable storage unit 1018 in a well known manner. The removable storage unit 1018 may represent a floppy disk, magnetic tape or an optical disk, and may be read by and written to by the removable storage drive 1016. As will be appreciated, the removable storage unit 1018 includes a computer usable storage medium having stored therein, computer software and/or data.

In accordance with various embodiments, the secondary memory 1012 may include other similar devices for allowing computer programs or other instructions to be loaded into the computer system 1000. Such devices may include, for example, a removable storage unit 1020, and an interface 1022. Examples of such may include a program cartridge and cartridge interface (such as that found in video game devices), a removable memory chip (such as an erasable programmable read only memory (EPROM), or programmable read only memory (PROM)) and associated socket, and other removable storage unit 1020 and interfaces 1022, which allow software and data to be transferred from the removable storage unit 1020 to the computer system 1000.

The computer system 1000 may further include a communication interface 1024. The communication interface 1024 allows software and data to be transferred between the computer system 1000 and external devices. Examples of the communication interface 1024 include, but may not be limited to a modem, a network interface (such as an Ethernet card), a communications port, a Personal Computer Memory Card International Association (PCMCIA) slot and card, and the like. Software and data transferred via the communication interface 1024 are in the form of a plurality of signals, hereinafter referred to as signals 1026, which may be electronic, electromagnetic, optical or other signals capable of being received by the communication interface 1024. Signals 1026 are provided to the communication interface 1024 via a communication path (e.g., channel) 1028. The communication path 1028 carries the signals 1026 and may be implemented using wire or cable, fiber optics, a telephone line, a cellular link, a radio frequency (RF) link and other communication channels.

In this document, the terms “computer program medium” and “computer usable medium” are used to generally refer to media such as the removable storage drive 1016, a hard disk installed in hard disk drive 1014, signals 1026, and the like. These computer program products provide software to the computer system 1000. The present disclosure is directed to such computer program products.

Computer programs (also referred to as computer control logic) are stored in the main memory 1010 and/or the secondary memory 1012. Computer programs may also be received via the communication infrastructure 1004. Such computer programs, when executed, enable the computer system 1000 to perform the features of the present disclosure, as discussed herein. In particular, the computer programs, when executed, enable the processor 1002 to perform the features of the present disclosure. Accordingly, such computer programs represent controllers of the computer system 1000.

In accordance with an embodiment of the disclosure, where the disclosure is implemented using a software, the software may be stored in a computer program product and loaded into the computer system 1000 using the removable storage drive 1016, the hard disk drive 1014 or the communication interface 1024. The control logic (software), when executed by the processor 1002, causes the processor 1002 to perform the functions of the present disclosure as described herein.

In various embodiments, the present disclosure is implemented primarily in hardware using, for example, hardware components such as application specific integrated circuits (ASIC). Implementation of the hardware state machine so as to perform the functions described herein will be apparent to persons skilled in the relevant art(s).

In yet another embodiment, the present disclosure is implemented using a combination of both the hardware and the software.

Systems, methods and computer program products are provided. In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement the disclosure in alternative embodiments.

While various embodiments of the present disclosure have been described above, it should be understood that they have been presented by way of example, and not limitation. It will be apparent to persons skilled in the relevant art(s) that various changes in form and detail can be made therein without departing from the spirit and scope of the present disclosure. Thus, the present disclosure should not be limited by any of the above described exemplary embodiments, but should be defined only in accordance with the following claims and their equivalents.

In addition, it should be understood that the figures illustrated in the attachments, which highlight the functionality and advantages of the present disclosure, are presented for example purposes only. The architecture of the present disclosure is sufficiently flexible and configurable, such that it may be utilized (and navigated) in ways other than that shown in the accompanying figures. The detailed description of exemplary embodiments herein makes reference to the accompanying drawings and figures, which show the exemplary embodiments by way of illustration only. While these exemplary embodiments are described in sufficient detail to enable those skilled in the art, it should be understood that other embodiments may be realized and that logical electrical, organization, and programming-related changes may be made without departing from the spirit and scope of the disclosure. It will be apparent to a person skilled in the pertinent art that this disclosure can also be employed in a variety of other applications. Thus, the detailed description herein is presented for purposes of illustration only and not of limitation. For example, the steps recited in any of the method or process descriptions may be executed in any order.

The present disclosure is described herein with reference to block diagrams and flowchart illustrations of methods, and computer program products according to various aspects of the disclosure. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the disclosure. It should be understood that the detailed description and specific examples, indicating exemplary embodiments of the system, are given for purposes of illustration only and not as limitations. Many changes and modifications within the scope of the instant disclosure may be made without departing from the spirit thereof, and the disclosure includes all such modifications. Corresponding structures, materials, acts, and equivalents of all elements in the claims below are intended to include any structure, material, or acts for performing the functions in combination with other claim elements as specifically claimed. The scope of the disclosure should be determined by the appended claims and their legal equivalents, rather than by the examples given above. Reference to an element in the singular is not intended to mean “one and only one” unless explicitly so stated, but rather “one or more.” Moreover, where a phrase similar to at least one of A, B, and C is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

1. A computer-readable medium having stored thereon sequences of instructions, the sequences of instructions including instructions which, in response to execution by a computer-based system for source control management, cause the computer-based system to perform operations comprising:
accessing, by the computer-based system, a transaction processing facility (TPF) platform via a web interface, wherein the web interface allows access to a data repository and a toolkit;
checking out, by the computer-based system, a selected component of a package of the TPF platform;
transmitting, by the computer-based system, a copy of the selected component to a local computer for modification by a user;
receiving, by the computer-based system, an edited copy of the selected component from the local computer;
checking in, by the computer-based system, the edited copy of the selected component;
comparing, by the computer-based system, the edited copy of the selected component with the selected component; and
providing, by the computer-based system, component level warnings of differences between the edited copy of the selected component and the selected component.

2. The computer-readable medium of claim 1, further comprising adding, by the computer-based system, a new component to the package, wherein the structure and properties of the package are automatically generated by the computer-based system.

3. The computer-readable medium of claim 1, further comprising searching multiple components of the package and filtering by search criteria, wherein the search criteria includes at least one of time of last edit, identity of editor, time of creation, status of the multiple components, and classification of the multiple components.

4. The computer-readable medium of claim 1, wherein the component level warnings include visible markers of conflicting code.

5. The computer-readable medium of claim 1, wherein authorization to access the selected component is restricted to an approved team of users.

6. The computer-readable medium of claim 5, wherein an individual user may be added to the approved team of users.

7. The computer-readable medium of claim 5, wherein a listing of the approved team of users is available to individuals of the approved team.

8. The computer-readable medium of claim 5, further comprising notifying, by the computer-based system, at least one user of the approved team in response to updates of the package at different stages of a staging workflow, wherein the at least one user of the approved team is able to opt-out of the notifying.

9. The computer-readable medium of claim 1, wherein a second copy of the selected component is transmitted to a second local machine for independent modification.

10. The computer-readable medium of claim 1, wherein the computer-based system tracks if version updates were made to the selected component while the copy of the selected component was checked out.

11. The computer-readable medium of claim 1, further comprising building, at the computer-based system, the package via the web interface.

12. The computer-readable medium of claim 11, further comprising freezing the package via the web interface, wherein no changes are permitted to the package.

13. The computer-readable medium of claim 11, further comprising promoting, via the web interface, the package to a staging workflow.

14. The computer-readable medium of claim 1, further comprising automatically creating a baseline snapshot of the package, by the computer-based system, in response to the package being at least one of loaded to production or falling back.

15. The computer-readable medium of claim 14, further comprising notifying, by the computer-based system, an approved team of users in response to the creating the baseline snapshot.

16. The computer-readable medium of claim 1, further comprising automatically creating a baseline snapshot of the package, by the computer-based system, based on predetermined schedule.

17. The computer-readable medium of claim 14, further comprising:
archiving packages after a first predefined time period in response to the creating the baseline snapshot; and
deleting archived packages after a second predefined time period, wherein the user is notified, prior to expiration of the second predefined time period, of the deleting of the archived packages.

18. A system embodied on a computer readable medium that provides for source control management, the system comprising:
a computer system having a transaction processing facility (TPF) platform, wherein the computer system comprises a repository, database access program, script library, secure shell, and Java servlet;
a toolkit module having a toolkit plugin that interacts with the Java servlet;
a web interface module for user interaction with the computer system; and
a data storage module for storing a package of the TPF platform, wherein the package comprises multiple components;
wherein a selected component is checked out by a user and a copy of the selected component is transmitted by the system to a local computer, and wherein the system receives an edited copy of the selected component from the local computer;
wherein the computer system checks in the edited copy of the selected component and compares the edited copy of the selected component with the selected component, and wherein the system provides component level warnings of differences between the edited copy of the selected component and the selected component.

19. The system of claim 18, wherein the computer system further comprises multiple repositories, wherein different levels of authorization are required for access to individual repositories of the multiple repositories.

20. The system of claim 18, wherein the system communicates using a secure communication channel to exchange data, and wherein the secure shell communicates to a remote system explorer via the secure communication channel.

21. A method comprising:
accessing, by a computer-based system for source control management, a transaction processing facility (TPF) platform via a web interface, wherein the web interface allows access to a data repository and a toolkit;
checking out, by the computer-based system, a selected component of a package of the TPF platform;
transmitting, by the computer-based system, a copy of the selected component to a local computer for modification by a user;
receiving, by the computer-based system, an edited copy of the selected component from the local computer;
checking in, by the computer-based system, the edited copy of the selected component;
comparing, by the computer-based system, the edited copy of the selected component with the selected component; and
providing, by the computer-based system, component level warnings of differences between the edited copy of the selected component and the selected component.
